(19) United States
(12) Patent Application Publication
(10) Pub. No.: US 2026/0081861 A1
(43) Pub. Date: Mar. 19, 2026

(54) DEBUGGING USING A PACKET-BASED NETWORKING PROTOCOL

(71) Applicant: Infineon Technologies AG, Neubiberg (DE)

(72) Inventors: Patrik Eder, Taufkirchen (DE); Albrecht Mayer, Waakirchen (DE)

(21) Appl. No.: 18/887,073

(22) Filed: Sep. 17, 2024

(51) Int. Cl. H04L 43/106

(52) U.S. Cl. CPC H04L 43/106

(57) ABSTRACT

Some aspects of the present disclosure relate to an integrated-circuit (IC) microcontroller (MCU) having a debug subsystem, a classifier module, and a network port. The debug system is configured to generate trace data in response to a trace trigger and provide the generated trace data to the classifier. The network port is configured to: receive network frames in accordance with a time-sensitive packet-switched networking protocol, encapsulate received payloads to generate network frames in accordance with the time-sensitive packet-switched networking protocol, transmit the generated network frames in accordance with the time-sensitive packet-switched networking protocol, generate timing information in accordance with the time-sensitive packet-switched networking protocol, and provide the timing information to the classifier. The classifier is configured to generate trace-data payloads based on the received trace data and the received timing information and provide the generated trace-data payloads to the network port.

### BACKGROUND

Computer-controlled systems such as, for example, vehicles or industrial equipment, often contain a debugging subsystem to assist in monitoring system performance and responding to unexpected behaviors, bugs, faults, and the like, which might affect the systems. Monitoring system performance may be accomplished using tracing tools of the debugging subsystems. Debugging subsystems may also be used in testing the operation of the systems during their development. Debugging subsystems may allow, for example, tracing the execution of instructions, the setting of breakpoints, the inspection and adjustment of variables, the control of instruction-execution flow, the triggering of related modules, and the provision of related data to an external debugging tool. External debugging tools typically interact with debugging subsystems in accordance with testing-specific standards such as, for example, JTAG (joint test action group) standards.

### BRIEF DESCRIPTION OF THE DRAWINGS

Some examples of circuits, apparatuses and/or methods will be described in the following by way of example only. In this context, reference will be made to the accompanying Figures.

FIG. 1 illustrates an example computer-controlled system in accordance with some embodiments of the disclosure.

FIG. 2 illustrates an example embodiment of a zone controller of the system of FIG. 1.

FIG. 3 illustrates example additional features of some embodiments of the zone controller of FIG. 2.

FIG. 4 illustrates example additional details of some elements of the zone controller of FIG. 3.

FIG. 5 illustrates an example format for a network frame generated by some implementations of the Ethernet port of FIG. 2.

FIG. 6 is a flowchart of an example process, in accordance with some embodiments of the disclosure, for performance by, for example, a zone controller or central controller of FIG. 1.

### DETAILED DESCRIPTION

The present disclosure will now be described with reference to the attached drawing figures, wherein like reference numerals are used to refer to like elements throughout, and wherein the illustrated structures and devices are not necessarily drawn to scale.

Many computer-controlled systems include a plurality of microcontrollers (MCUs) located throughout the system. For example, an automobile may have dozens of MCUs located in disparate locations throughout the automobile. Conventional debugging subsystems may require specialized and/or proprietary connectors, communication protocols, and debugging equipment, which makes debugging and tracing operations cumbersome and difficult in deployed systems-particularly in systems where a target MCU is situated in a difficult-to-access location, thereby making accessing its debugging subsystem particularly challenging in deployment. Furthermore, if debugging operations involve multiple interacting MCUs, it may be difficult to discern accurate event timelines across the different MCUs if their respective local clocks are not synchronized.

In some embodiments of computer-controlled systems in accordance with the disclosure, the MCUs are communicatively interconnected using a real-time-capable packet-switched (or packet-based) networking protocol, such as a Time Sensitive Networking (TSN) Ethernet protocol. TSN Ethernet includes a set of standards enhancing conventional Ethernet networking in order to support real-time communication, which may be particularly useful for automotive safety systems, industrial robotic systems, audio/video streaming, and the like. TSN Ethernet allows for the development and deployment of standardized, modular, flexible, packet-switched communication networks that provide features that would otherwise require direct links between nodes and specialized communication protocols, while forgoing having direct links between all pairs of nodes and specialized communication protocols.

TSN Ethernet is particularly useful in automotive settings. For automotive-safety-relevant systems such as ADAS (Advanced Driver Assistance System), TSN Ethernet allows, for example, for the synchronization of multiple sensors for sensor fusion and real-time processing with guaranteed communication bandwidth among components. For automotive infotainment systems, TSN Ethernet allows, for example, having synchronized audio and video streams, precise distribution of audio signals to different speakers within a vehicle, enhanced communication, and an improved user experience.

Nodes in a TSN Ethernet network may be synchronized by setting up a time distribution tree for the network with one node designated as having the grandmaster clock as a common reference source. The grandmaster clock time is then cascaded through the clock tree, one level at a time, between pairs of directly connected nodes, until the local clocks of all of the nodes are synchronized with the grandmaster clock. Pairs of directly connected nodes have consistent delay times between them and so can synchronize their respective local clocks fairly precisely (e.g., within a few nanoseconds). The cascading synchronization of node clocks may be performed in accordance with a precision time protocol (PTP) such as, for example, defined in the IEEE 1588 standard.

TSN Ethernet allows some embodiments of computer-controlled systems in accordance with the disclosure to maintain time-sensitive communicative contact among the MCUs of the system, wherein each MCU is configured to have a network-aware debugging subsystem allowing debugging and/or tracing operations during the development of the system and during its deployment using TSN Ethernet standards. Some Ethernet standards relevant for these computer-controlled systems are IEEE 802.1Q for virtual local area networks (VLANs), IEEE 802.1AS for time synchronization, IEEE 802.1Qav for forwarding and queuing enhancements for time-sensitive streams (including credit-based shaping (CBS)), and IEEE 802.1Qbv for enhancements to traffic scheduling (including time-aware shaping (TAS)).

Each MCU is thus able to generate and provide, via TSN Ethernet, time-sensitive debug and trace information to, for example, a controller MCU of the computer-controlled system running a debugging tool or an external debugging tool connected to another MCU of the computer-controlled system or another node of the TSN Ethernet network. The system-internal or system-external debugging tool can then chronologically merge debug and/or trace information received via TSN Ethernet from multiple MCUs in the computer-controlled system, which, for example, enhances the ability to diagnose complex bugs involving multiple MCUs.

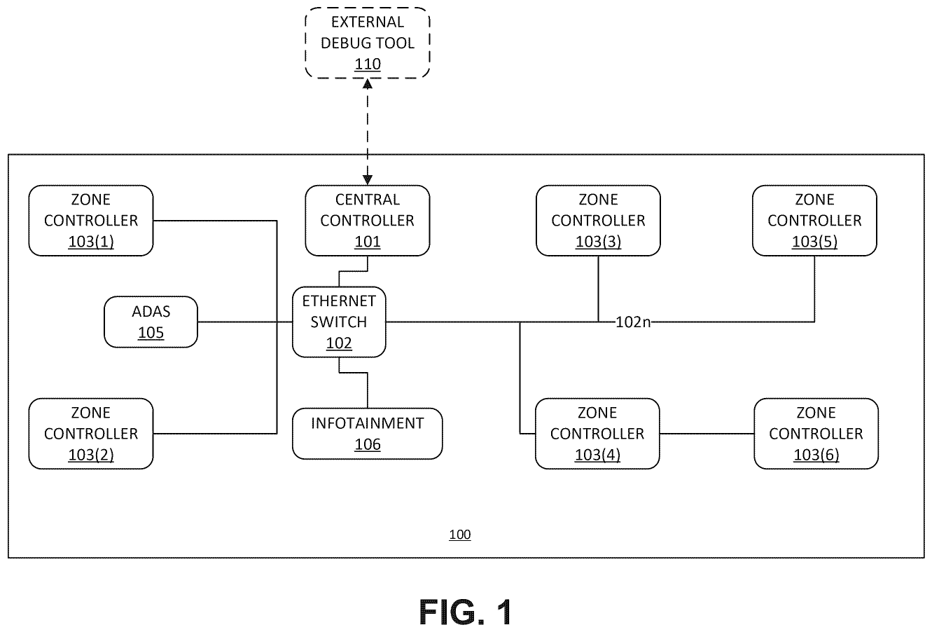

FIG. 1 illustrates an example computer-controlled system 100 in accordance with some embodiments of the disclosure. System 100 may correspond, for example, to an automotive system. The system 100 comprises a central controller 101 and a plurality of zone controllers 103 (e.g., zone controllers 103(1)-103(6)). The central controller 101 and the zone controllers 103 correspond to the above-described MCUs. The system 100 further includes an Advanced Driver Assistance System (ADAS) module 105 and an infotainment module 106. The controllers and modules 101, 103, 105, and 106 of the system 100 are communicatively interconnected by a TSN Ethernet network 102n, which includes an Ethernet switch 102, for routing network frames among the various nodes of the network. The Ethernet network 102n may include additional connections, switches, routers, bridges, and other networking infrastructure (not shown). The TSN Ethernet network 102n allows its nodes to set up and maintain synchronized local clocks and communicate using TSN Ethernet network frames.

An optional external debug tool 110 may selectively connect to the central controller 101, one of the zone controllers 103, or another node (not shown) of the network 102n. While connected to one node of the network 102n, the external debug tool 110 may communicate with any of the controllers 101 and 103 using the network 102n. This is particularly useful for communicating with, and obtaining time-sensitive debug or trace data from, deeply embedded and difficult-to-access zone controllers 103.

Each of the zone controllers 103 and the central controller 101 is configured to generate TSN Ethernet frames for encapsulating debug and trace information and transmit the frames using the TSN Ethernet network 102n. Note that frames is the term generally used to refer to the data packets at the data-link layer, e.g., Ethernet frames, while packets, on its own, may generally be understood to refer to the data packets at the network layer, e.g., IP packets. The generation of debug and/or trace information may be initiated and terminated in response to, for example, a request from the external debug tool 110, error-processing by the central controller 101, or a scheduled event.

In one example implementation, the external debug tool 110 sets up debugging sessions on zone controllers 103(1) and 103(6) and then receives corresponding trace data from those zone controllers. If, due to the network setup (e.g., additional network bridges (not shown), data frames arrive out of chronological order from those zone controllers, then since, as described below, the data frames include debug timestamps, the debug tool 110 can reorder the data frames into a chronologically correct order. In another example implementation, since zone controllers 103(1) and 103(6) have synchronized clocks, the debug tool 110 can trigger mechanisms inside their respective debugging subsystems (described below) to fire at a predefined time, which allows the debug tool 110 to stop program execution in multiple devices (e.g., zone controllers 103(1) and 103(6)) at the same time (with an error margin that may be in the nanosecond scale).

The solution to support this feature is to use existing data comparison event triggers and connect the time value vector of the ethernet module to an input and enable the comparison to the network time: The reaction to these triggers are configuration dependent and may range from intrusive debug such as program execution stop to non-intrusive (i.e. the program execution continues) trace start/stop.

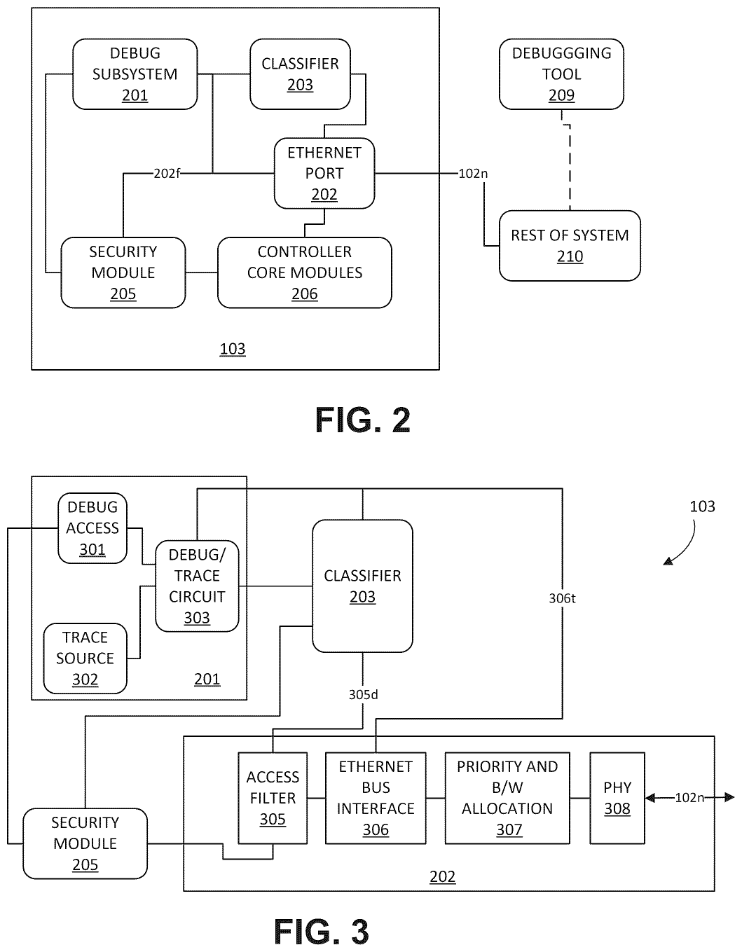

FIG. 2 illustrates an example embodiment of a zone controller 103 of the system 100 of FIG. 1. The zone controller 103 is an integrated-circuit (IC) device comprising a debug subsystem 201, an Ethernet network port 202, a classifier module 203, a security module 205, and controller core modules 206, wherein the elements 201, 202, 203, 205, and 206 are interconnected by an interconnect fabric 202f, which may comprises one or more buses. The zone controller 103 connects to the rest of the system 210 via the TSN Ethernet network 102n. A debugging tool 209 may be connected to the controller 103, for example, through the rest of the system 210, or directly (not shown), via the network 102n. The debugging tool 209 may correspond to the removable external debug tool 110 of FIG. 1 or, alternatively, may correspond to a module of the system 100 such as, for example, a debug tool module (not shown) of the central controller 101.

The debug subsystem 201 is configured to generate and provide debug or trace data in response to debug or trace requests. Generally, trace data comprises a sequential, timestamped, log of operations carried out by one or more modules within, or controlled by, the zone controller 103. Such modules can include, for example, processors of the controller core modules 206, the ethernet port 202, and/or sensors and devices (not shown) controlled by the zone controller 103. A trace request may designate particular components or operations for tracing. Generally, debug data comprises more targeted and algorithmically determined data related to program execution, including, for example, variable values at selected breakpoints, which may be stored, for example, in device registers or similar on-device memory. Breakpoints may, for example, be preset for particular instructions or be dynamically set if certain conditions are met. Debug requests may also include changing variable values or altering the execution of instructions.

The debug data or trace data generated by the debug subsystem 201 is provided to the classifier 203, which generates corresponding debug-data or trace-data payloads that also include corresponding timing information (e.g., timestamps) and which are provided to the Ethernet port 202. The timing information is based on a local clock (not shown) that is synchronized by the Ethernet port 202.

The Ethernet port 202 is configured to send and receive TSN Ethernet frames, which comprises encapsulating payloads for transmission with a corresponding Ethernet header and decapsulating received payloads for processing by the appropriate module of the zone controller 103. The Ethernet port 202 is configured to adjust the local clock time based on timing information received in accordance with using TSN Ethernet. Adjusting the local clock time corresponds to generation of timing information in accordance with the TSN Ethernet protocol. That timing information may be provided to the classifier 203 by, for example, allowing the classifier 203 access to, and use of, the local clock. The Ethernet port 202 may alternatively generate and provide timing information by other means, such as, for example, updating one or more register or counter values accessible by the classifier 203.

The security module 205 may be used to control access to trace and debug features, control access of the debug subsystem to the rest of the MCU, and to encrypt generated trace and debug data. Trace and debug features can be used by adversarial actors to hack system 100 to obtain unauthorized information or perform unauthorized actions that may be deleterious to the system 100 or its owner or operator. The security module 205 may limit access to intrusive debug operations in certain operational modes of the system 100 (for example, if the system 100 is a vehicle and the vehicle is in motion). The access control may be accomplished by requiring valid signature keys for trace and debug requests in order to allow access (which would otherwise be blocked by default).

The security module 205 may, in addition, support encryption of generated trace and/or debug data. Accordingly, the security module 205 may be configured to verify that debug and trace requests are received from trusted requestors and, if so, enable access to the debug subsystem 201 and provide corresponding security configuration information (e.g., encryption keys or encrypted data) to the classifier 203 and the Ethernet port 202 for processing (e.g., encrypting) trace and debug data received from the debug system 201.

The security module 205 may be a hardware security module (HSM). In some embodiments, the security module 205 may be implemented by using ARM TrustZone technology (ARM and TrustZone are registered trademarks of ARM Limited of Cambridge, UK) or Intel Software Guard Extensions (SGX) (Intel is a registered trademark of Intel Corporation of Santa Clara, California).

FIG. 3 illustrates example additional features of some embodiments of the zone controller 103 of FIG. 2. Debug system 201 comprises debug access module 301, trace source 302, and debug/trace circuit 303. Debug access module 301 communicates securely with the security module 205. The debug access module 301 may, for example, transmit a configuration request, based on a request from the debugging tool 209 (not shown in FIG. 3), for authenticity and/or validity verification by the security module 205. In response to a request by the debugging tool 209, the trace source 302 may provide trace data to the debug/trace circuit 303. The debug/trace circuit 303 may process debug and trace requests and the resultant debug and trace data.

The Ethernet port 202 comprises an access filter 305, an Ethernet bus interface 306, a priority and bandwidth allocation module 307, and a PHY (physical layer) module 308. The security module 205 may use the access filter 305 to selectively allow and disallow access to the debugging system via the Ethernet port 202. The access filter 305 may transmit and receive debug and trace communication 305d to and from the classifier 203. The Ethernet bus interface 306, connected between the access filter 305 and the priority and bandwidth allocation module 307, may provide time synchronization information 306t to the classifier 203 and the debug/trace circuit 303 to allow updates of the debug and trace data timestamps.

The priority and bandwidth allocation module 307 is configured to assign corresponding traffic class (TC) priority classifications to network frames generated by the Ethernet port 202. The priority and bandwidth allocation module 307 also regulates bandwidth allocation and data flow to manage the transmission of time-sensitive data streams using so that they have consistent access to the Ethernet network. The transmission may be managed using, for example, a credit-based shaper (CBS), which assigns credits to various streams that accumulate over time and determine when a particular stream can send frames. The transmission may alternatively be managed using, for example, a time-aware shaping (TAS), which assigns transmission time slots based on priority.

In some example implementations in which the TSN Ethernet network 102n uses eight TC classifications ranging from TC0 to TC7, TC7 represents the highest priority, TC0 represents the lowest priority, and intermediate classifications represent correspondingly intermediate priority levels. TC0 frames may be considered to have a “best effort” priority level, which are sent after higher-priority streams are done with their communication needs, but with an option to set a minimum quality of service (QoS) bandwidth by using defined CBS credits or TAS time slots.

In order to avoid interference with nominal Ethernet communication of the controller 103, typical trace-data frames may be assigned a low-priority TC classification such as, for example, TC0. Some trace-data frames, however, such as, for example, critical trace information frames, may be assigned an intermediate priority classification.

Meanwhile, in order to ensure transmission of important debug control information, debug-data frames may be assigned high-priority TC classification such as, for example, TC7.

Debug control communication, such as messages generated by a critical event like an alarm, is assigned priority class TC7. The high-priority classification ensures, for example, that a misbehaving zone controller 103 can be identified and stopped if needed via a debug side access to that controller 103. Since intrusive debug access may alter the execution flow of a controller 103, that access needs to be guarded by an element that prevents other communication when the controller 103 is not ensured to be in a safe state. This may be accomplished using a safety gate (not shown) in or between the Ethernet bus interface 306 and the priority and bandwidth allocation module 307.

The physical layer (PHY) module 308 interfaces between the priority and bandwidth allocation module 307 and the TSN Ethernet network 102n. The PHY module 308 convert between digital data from media access control (MAC) layer modules (e.g., the priority and bandwidth allocation module 307) in the Ethernet port 202 and electrical signals for transmission over the physical medium of the Ethernet network 102n.

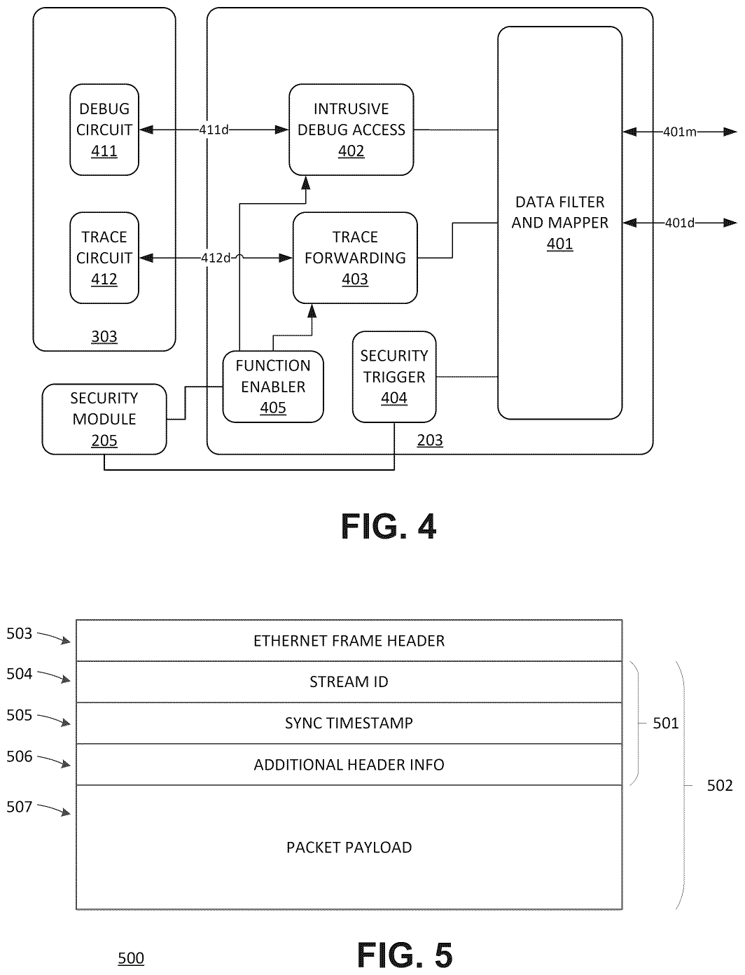

FIG. 4 illustrates example additional details of some elements of zone controller 103 of FIG. 3. Trace/debug circuit 303 comprises a debug circuit 411 and a trace circuit 412. The classifier 203 is used to map incoming data to a corresponding recipient such as, for example, debug control, and feed data to the correct outgoing channel. Incoming data may be classified by information in the network communication such as, for example, MAC or VLAN address. The classifier 203 comprises data filter and mapper module 401, which is configured to transmit metadata 401m and data 401d to/from one or more other components (not shown in FIG. 4) of the controller 103. The data 401d and corresponding metadata 401m may be provided in parallel. Metadata 401m may comprise, for example, existing transaction metadata for corresponding data 401d, such as Master IDs on a bus, a content ID, or a defined verbosity level. The metadata 401m may be used to determine a trace data class for the corresponding data 401d.

The classifier 203 further comprises an intrusive debug access module 402 connected to the data filter and mapper 401 via a debug port, a trace forwarding module 403 connected to the data filter and mapper 401 via a trace input, and a security trigger 404 connected to the data filter and mapper 401 via a default port. The intrusive debug access module 402 receives classified traffic 411d from the debug circuit 411. The trace forwarding module 403 receives captured data 412d from the trace circuit 412. The security trigger 404 provides interrupt and status information to the security module 205. The classifier 203 further comprises function enabler 405, which selectively enables or disables the intrusive debug access 402 and the trace forwarding module 403, based on activation instructions received from the security module 205.

FIG. 5 illustrates an example format for a network frame 500 generated by some implementations of the Ethernet port 202 of FIG. 2. The network frame 500 comprises an Ethernet header 503 and a payload 502, which may also be referred to as a body. The Ethernet header 503 comprises information such as the frame source address (e.g., the MAC (medium access control) address of the zone controller 103) and the frame destination address (e.g., the MAC address of the debugging tool 209). The payload 502 is a debug or trace data packet, which comprises a header 501 and a payload (or body) 507. The header 501 may be, for example, a custom format or a modified AVTP (audio/video transport protocol) format and comprises identifying and timing (e.g., timestamp and counter) information for the corresponding payload 507.

AVTP, defined by the IEEE 1722 standard, is used for transmitting time-sensitive audio/video content over TSN Ethernet and comprises fields such as stream ID and AVTP time. Data packet 502 repurposes the AVTP stream ID field as debugging stream ID field 504 to identify the debugging stream for the corresponding debug or trace data. Using a debug stream ID field 504 allows for tagging, filtering, and handling trace data based on a trace source independent of a device's MAC address (or other predefined and unalterable parameter). This allows, for example, assigning local trace sources to different stream IDs for systems using multiple time domains.

Data packet 502 repurposes the AVTP time field as sync timestamp field 505 to store a corresponding synchronized timestamp for the data in the packet payload 507. For trace data, the data packet 502 may further store a trace timestamp and a pulse count in the packet payload 507 or, alternatively, in the additional header info field 506. The pulse count may be a count of received pulse-per-second (PPS) pulses received at the zone controller 103 since a reset, while the trace timestamp may be a timer time based on a count of processor clock cycles of the zone controller 103.

PPS signals received by the Ethernet port 202 of a zone controller 103 may be provided to the debug/trace circuit 303 as synchronization information 306t. The debug/trace circuit 303 may incorporate a local timekeeping unit such as, for example, a counter incremented by the clock used to drive the overall trace logic. This counter may be initialized, for example, at device power up or at the start of a trace session, and be free running afterwards. The debug/trace circuit 303 includes a second timer that is also incremented by the same clock, but is reset not only at the start of a trace session, but also any time a PPS pulse is detected. In one example implementation, both counters are initialized to zero at the start of a trace session. With each PPS pulse, the PPS count gets captured by the debug/trace circuit and is then reset to zero. The reset (or forced overflow) triggers a marker message that includes all the values valid before the reset of the PPS counter. With this information, a debug tool can derive further information such as, for example, determining timing changes and aligning timestamps based on the PPS synchronization. In one example implementation, a 100 MHz clocked counter uses a 27-bit wide counter to fit the maximum possible count value. In some alternative implementations, where the relevant clocks are closely synchronized, narrower counters may be sufficient to track differences (e.g., if the 100 MHz clock deviates by ˜200 PPM, then a 10-bit wide counter would be sufficient since the more-significant bits would be relatively constant).

While various embodiments of a zone controller 103 have been provided above, it should be noted that the central controller 101 of the system 100 of FIG. 1 may comprise all of the above-described modules of a zone controller 103. A central controller 101 may contain additional control-related modules not present in a zone controller 103 or may, alternatively, comprise the same, or fewer, modules.

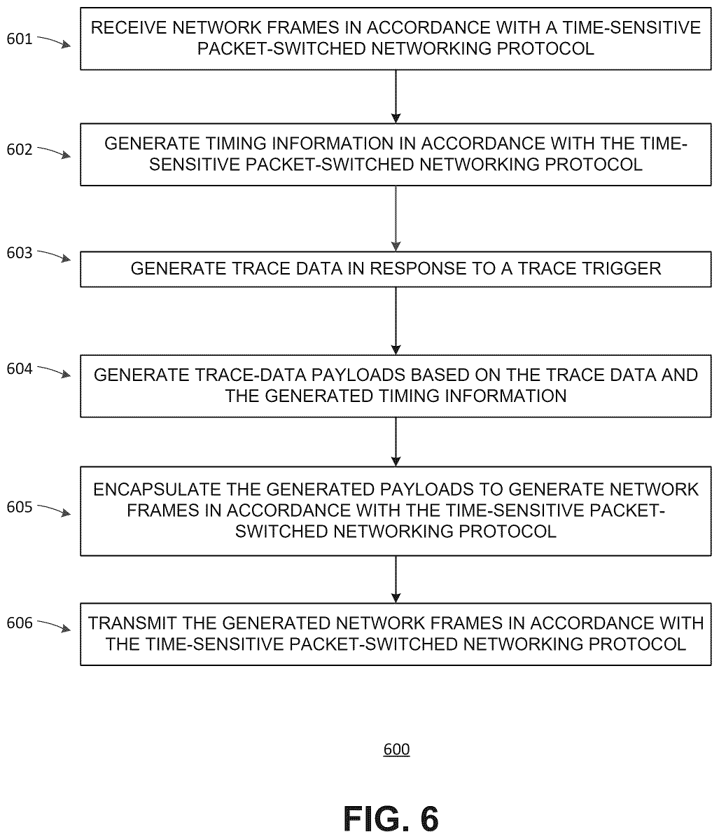

FIG. 6 is a flowchart of an example process 600, in accordance with some embodiments of the disclosure, for performance by, for example, a zone controller 103 or central controller 101 of FIG. 1. The process 600 starts with step 601, which is to receive network frames in accordance with a time-sensitive packet-switched networking protocol, e.g., TSN Ethernet. The process continues with step 602, which is to generate timing information in accordance with the time-sensitive packet-switched networking protocol. Subsequently, step 603 is to generate trace data in response to a trace trigger received, e.g., from a debugging tool. The process then proceeds with step 604, which is to generate trace-data payloads based on the trace data and the generated timing information. Later, step 605 is to encapsulate the generated payloads to generate network frames in accordance with the time-sensitive packet-switched networking protocol. The process then goes to step 606, which is to transmit, e.g., to the requesting debugging tool, the generated network frames in accordance with the packet-switched networking protocol.

While embodiments have been illustrated and described with respect to one or more implementations, alterations and/or modifications may be made to the illustrated examples without departing from the spirit and scope of the appended claims. In particular regard to the various functions performed by the above described components or structures (assemblies, devices, circuits, circuitries, systems, etc.), the terms used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations.

Examples can include subject matter such as a method, means for performing acts or blocks of the method, at least one machine-readable medium including instructions that, when performed by a machine cause the machine to perform acts of the method or of an apparatus or system for detecting a non-transmitting target according to embodiments and examples described herein.

Example 1 is an integrated-circuit (IC) microcontroller (MCU) including a debug subsystem, a classifier, and a network port. The debug subsystem is configured to generate trace data in response to a trace trigger and provide the generated trace data to the classifier. The network port is configured to: receive network frames in accordance with a time-sensitive packet-switched networking protocol, encapsulate received payloads to generate network frames in accordance with the time-sensitive packet-switched networking protocol, transmit the generated network frames in accordance with the time-sensitive packet-switched networking protocol, generate timing information in accordance with the time-sensitive packet-switched networking protocol, and provide the timing information to the classifier. The classifier is configured to generate trace-data payloads based on the trace data provided by the debug subsystem and the timing information provided by the network port and provide the generated trace-data payloads to the network port.

Example 2 includes the subject matter of example 1, including or omitting optional elements, wherein the network port is configured to encapsulate for transmission trace-data payloads received from the classifier with a header including a debugging stream identifier.

Example 3 includes the subject matter of example 2, including or omitting optional elements, wherein the header further includes a trace timestamp and a pulse count.

Example 4 includes the subject matter of example 3, including or omitting optional elements, wherein the header conforms with an audio/video transport protocol (AVTP) and the header further includes an AVTP timestamp.

Example 5 includes the subject matter of example 1, including or omitting optional elements, wherein: the debug subsystem is further configured to provide debugging information to the classifier in response to a debug request; and the classifier is configured to: generate debug-data payloads based on the debugging information provided by the debug subsystem and the timing information provided by the network port; and provide the generated debug-data payloads to the network port.

Example 6 includes the subject matter of example 5, including or omitting optional elements, wherein the network port is configured to include a low-priority traffic class (TC) priority classification for the network frames generated from the trace-data payloads received from the classifier and include a high-priority traffic class (TC) priority classification for the network frames generated from the debug-data payloads received from the classifier.

Example 7 includes the subject matter of example 1, including or omitting optional elements, wherein: the MCU further comprises a security module configured to selectively allow and disallow access to the debugging subsystem and provide security configuration information to at least one of the classifier and the network port; and the network port is configured to encrypt the generated network frames in accordance with the security configuration information from the security module.

Example 8 includes the subject matter of example 1, including or omitting optional elements, wherein the MCU comprises a local clock configured to provide timing information to the classifier and the MCU is configured to set the local clock based on the generated timing information.

Example 9 includes the subject matter of example 8, including or omitting optional elements, wherein the local clock is further configured to provide timing information to the debug subsystem.

Example 10 is a method for an integrated-circuit (IC) microcontroller (MCU). The method includes receiving network frames in accordance with a time-sensitive packet-switched networking protocol, generating timing information in accordance with the time-sensitive packet-switched networking protocol, generating trace data in response to a trace trigger, generating trace-data payloads based on the trace data and the generated timing information, encapsulating payloads to generate network frames in accordance with the time-sensitive packet-switched networking protocol, and transmitting the generated network frames in accordance with the time-sensitive packet-switched networking protocol.

Example 11 includes the subject matter of example 10, including or omitting optional elements, wherein the encapsulating of payloads comprises encapsulating with a header including a debugging stream identifier.

Example 12 includes the subject matter of example 11, including or omitting optional elements, wherein the header further includes a trace timestamp and a pulse count.

Example 13 includes the subject matter of example 12, including or omitting optional elements, wherein the header conforms with an audio/video transport protocol (AVTP) and the header further includes an AVTP timestamp.

Example 14 includes the subject matter of example 10, including or omitting optional elements, wherein the method further includes providing debugging information in response to a debug request, generating debug-data payloads based on the debugging information and the timing information, and encapsulating the generated debug-data payloads for transmission.

Example 15 includes the subject matter of example 14, including or omitting optional elements, further including: including a low-priority traffic class (TC) priority classification for the network frames generated from the trace-data payloads and including a high-priority traffic class (TC) priority classification for the network frames generated from the debug-data payloads.

Example 16 includes the subject matter of example 10, including or omitting optional elements, further including selectively allowing and disallowing access to a debugging subsystem, providing security configuration information to modules of the MCU, and encrypting the generated network frames in accordance with the security configuration information.

Example 17 includes the subject matter of example 10, including or omitting optional elements, further including setting a local clock based on the generated timing information.

Example 18 includes the subject matter of example 10, including or omitting optional elements, further including connecting to an external debugging tool, transmitting the trace trigger for a second MCU from the debugging tool to the second MCU, and transmitting generated network frames from the second MCU to the debugging tool.

Example 19 is a computer-controlled system having at least a first microcontroller (MCU) and a second MCU. Each of the first and second MCUs includes a debug subsystem, a classifier, and a network port. The debug subsystem is configured to generate trace data in response to a trace trigger and provide the generated trace data to the classifier. The network port is configured to: receive network frames in accordance with a time-sensitive packet-switched networking protocol, encapsulate received payloads to generate network frames in accordance with the time-sensitive packet-switched networking protocol, transmit the generated network frames in accordance with the time-sensitive packet-switched networking protocol, generate timing information in accordance with the time-sensitive packet-switched networking protocol, and provide the timing information to the classifier. The classifier is configured to generate trace-data payloads based on the trace data provided by the debug subsystem and the timing information provided by the network port and provide the generated trace-data payloads to the network port. The first MCU is configured to generate the trace trigger for the second MCU.

Example 20 includes the subject matter of example 19, including or omitting optional elements, wherein the first MCU is configured to connect to an external debugging tool, provide, to the external debugging tool, access to system resources of the first MCU, transmit the trace trigger for the second MCU from the external debugging tool to the second MCU, and transmit the generated network frames from the second MCU to the external debugging tool.

The foregoing description of one or more implementations provides illustration and description, but is not intended to be exhaustive or to limit the scope of the example embodiments to the precise form disclosed. Modifications and variations are possible in light of the above teachings or may be acquired from practice of various implementations of the example embodiments.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In the present disclosure like reference numerals are used to refer to like elements throughout, and wherein the illustrated structures and devices are not necessarily drawn to scale.

As utilized herein, terms “module”, “component,” “system,” “circuit,” “circuitry,” “element,” and the like are intended to refer to a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuitries can reside within a process, and circuitry can be localized on one computer and/or distributed between two or more computers. A set of elements or a set of other circuitry can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include field gates, logical components, hardware encoded logic, register transfer logic, one or more processors therein to execute software and/or firmware that confer(s), at least in part, the functionality of the electronic components.

It will be understood that when an element is referred to as being “electrically connected” or “electrically coupled” to another element, it can be physically connected or coupled to the other element such that current and/or electromagnetic radiation can flow along a conductive path formed by the elements. Intervening conductive, inductive, or capacitive elements may be present between the element and the other element when the elements are described as being electrically coupled or connected to one another. Further, when electrically coupled or connected to one another, one element may be capable of inducing a voltage or current flow or propagation of an electro-magnetic wave in the other element without physical contact or intervening components. Further, when a voltage, current, or signal is referred to as being “applied” to an element, the voltage, current, or signal may be conducted to the element by way of a physical connection or by way of capacitive, electro-magnetic, or inductive coupling that does not involve a physical connection.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

What is claimed is:

1. An integrated-circuit (IC) microcontroller (MCU) comprising a debug subsystem, a classifier, and a network port wherein:
the debug subsystem is configured to:
generate trace data in response to a trace trigger; and
provide the generated trace data to the classifier;
the network port is configured to:
receive network frames in accordance with a time-sensitive packet-switched networking protocol;
encapsulate received payloads to generate network frames in accordance with the time-sensitive packet-switched networking protocol;
transmit the generated network frames in accordance with the time-sensitive packet-switched networking protocol;
generate timing information in accordance with the time-sensitive packet-switched networking protocol; and
provide the timing information to the classifier; and
the classifier is configured to:
generate trace-data payloads based on the trace data provided by the debug subsystem and the timing information provided by the network port; and
provide the generated trace-data payloads to the network port.

2. The MCU of claim 1, wherein the network port is configured to encapsulate for transmission trace-data payloads received from the classifier with a header including a debugging stream identifier.

3. The MCU of claim 2, wherein the header further includes a trace timestamp and a pulse count.

4. The MCU of claim 3, wherein:
the header conforms with an audio/video transport protocol (AVTP); and
the header further includes an AVTP timestamp.

5. The MCU of claim 1, wherein:
the debug subsystem is further configured to provide debugging information to the classifier in response to a debug request; and
the classifier is configured to:
generate debug-data payloads based on the debugging information provided by the debug subsystem and the timing information provided by the network port; and
provide the generated debug-data payloads to the network port.

6. The MCU of claim 5, wherein the network port is configured to:
include a low-priority traffic class (TC) priority classification for the network frames generated from the trace-data payloads received from the classifier; and
include a high-priority traffic class (TC) priority classification for the network frames generated from the debug-data payloads received from the classifier.

7. The MCU of claim 1, wherein:
the MCU further comprises a security module configured to:
selectively allow and disallow access to the debugging subsystem; and
provide security configuration information to at least one of the classifier and the network port; and
the network port is configured to encrypt the generated network frames in accordance with the security configuration information from the security module.

8. The MCU of claim 1, wherein:
the MCU comprises a local clock configured to provide timing information to the classifier; and
the MCU is configured to set the local clock based on the generated timing information.

9. The MCU of claim 8, wherein the local clock is further configured to provide timing information to the debug subsystem.

10. A method for an integrated-circuit (IC) microcontroller (MCU), the method comprising:
receiving network frames in accordance with a time-sensitive packet-switched networking protocol;
generating timing information in accordance with the time-sensitive packet-switched networking protocol;
generating trace data in response to a trace trigger;
generating trace-data payloads based on the trace data and the generated timing information;
encapsulating the generated payloads to generate network frames in accordance with the time-sensitive packet-switched networking protocol; and
transmitting the generated network frames in accordance with the time-sensitive packet-switched networking protocol.

11. The method of claim 10, wherein the encapsulating of the generated payloads comprises encapsulating with a header including a debugging stream identifier.

12. The method of claim 11, wherein the header further includes a trace timestamp and a pulse count.

13. The method of claim 12, wherein:
the header conforms with an audio/video transport protocol (AVTP); and
the header further includes an AVTP timestamp.

14. The method of claim 10, wherein the method further comprises:
providing debugging information in response to a debug request;
generating debug-data payloads based on the debugging information and the timing information; and
encapsulating the generated debug-data payloads for transmission.

15. The method of claim 14, further comprising:
including a low-priority traffic class (TC) priority classification for the network frames generated from the trace-data payloads; and
including a high-priority traffic class (TC) priority classification for the network frames generated from the debug-data payloads.

16. The method of claim 10, further comprising:
selectively allowing and disallowing access to a debugging subsystem;
providing security configuration information to modules of the MCU; and
encrypting the generated network frames in accordance with the security configuration information.

17. The method of claim 10, further comprising setting a local clock based on the generated timing information.

18. The method of claim 10, further comprising:
connecting to an external debugging tool;
transmitting the trace trigger for a second MCU from the debugging tool to the second MCU; and
transmitting generated network frames from the second MCU to the debugging tool.

19. A computer-controlled system comprising at least a first microcontroller (MCU) and a second MCU, wherein:
each of the first and second MCUs comprises a debug subsystem, a classifier, and a network port wherein:
the debug subsystem is configured to:
generate trace data in response to a trace trigger; and
provide the generated trace data to the classifier;
the network port is configured to:
receive network frames in accordance with a time-sensitive packet-switched networking protocol;
encapsulate received payloads to generate network frames in accordance with the time-sensitive packet-switched networking protocol;
transmit the generated network frames in accordance with the time-sensitive packet-switched networking protocol;
generate timing information in accordance with the time-sensitive packet-switched networking protocol; and
provide the timing information to the classifier; and
the classifier is configured to:
generate trace-data payloads based on the trace data provided by the debug subsystem and the timing information provided by the network port; and
provide the generated trace-data payloads to the network port; and
the first MCU is configured to generate the trace trigger for the second MCU.

20. The computer-controlled system of claim 19, wherein the first MCU is configured to:
connect to an external debugging tool;
provide, to the external debugging tool, access to system resources of the first MCU;
transmit the trace trigger for the second MCU from the external debugging tool to the second MCU; and
transmit the generated network frames from the second MCU to the external debugging tool.
